(19) United States
(12) Patent Application Publication
(10) Pub. No.: US 2020/0027414 A1
(43) Pub. Date: Jan. 23, 2020

(54) LIQUID CRYSTAL DEVICE AND ELECTRONIC APPARATUS

(71) Applicant: SEIKO EPSON CORPORATION, Tokyo (JP)

(72) Inventor: Toru AOKI, Shiojiri-shi (JP)

(73) Assignee: SEIKO EPSON CORPORATION, Tokyo (JP)

(21) Appl. No.: 16/517,815

(22) Filed: Jul. 22, 2019

(30) Foreign Application Priority Data
Jul. 23, 2018 (JP) 2018-137321

(51) Int. Cl. G09G 3/36

(52) U.S. Cl. CPC G09G 3/3614; G09G 2310/0297; G09G 2310/0248

(57) ABSTRACT

A liquid crystal device performing, at a predetermined frame rate, image writing of supplying a video signal to a pixel via a signal line includes, an inversion period setting unit configured to set an inversion period, in which a polarity of the video signal is inverted, to be a length that includes two or more frames for performing the image writing, and a pre-charge unit configured to perform, in a predetermined period from inversion of the polarity of the video signal until elapse of the inversion period, pre-charge, in which a pre-charge signal is supplied to the signal line, for a first frame, but not to perform the pre-charge for at least one frame among second and subsequent frames.

The present application is based on and claims priority from JP Application Serial Number 2018-137321, filed on Jul. 23, 2018, the disclosure of which is hereby incorporated by reference herein in its entirety.

### BACKGROUND

### 1. Technical Field

The present disclosure relates to a liquid crystal device and an electronic apparatus.

### 2. Related Art

In a case of a liquid crystal device that uses liquid crystal elements to display images, there is known a driving method in which the polarity of the voltage applied to the liquid crystal element is inverted at every constant period to prevent image sticking on the display image. In addition, there is known a technique in which a pre-charge signal is supplied to a signal line before a video signal is supplied to pixels through the signal line to improve the image quality of the displayed image.

For example, JP-A-2010-127953 discloses a driving method in which a voltage having a negative polarity with respect to a reference potential of a video signal is supplied at a timing prior to the video signal, regardless of the polarity of the video signal. JP-A-2006-259224 discloses a driving method in which a first pre-charge signal having a potential of an approximately lowest voltage of a video signal and a second pre-charge signal having a potential of an approximately middle of the amplitude of a video signal are sequentially supplied during a blanking period of each horizontal scanning period, the second pre-charge signal having the same polarity as the video signal. JP-A-2012-53407 discloses a method for displaying an image using a vertical scanning period including a horizontal scanning period in which a pre-charge signal is supplied in accordance with the polarity of a video signal and a horizontal scanning period in which supplying of the pre-charge signal is stopped.

In recent years, to improve the image quality of a displayed image, the frame rate at the time of supplying video signals tends to be increased.

However, improvement of the image quality using pre-charge and securing of the writing time for writing video signals to the pixels are in a trade-off relationship. In particular, as the frame rate increases, the writing time reduces due to a time required for pre-charging, which poses a problem in that a sufficient writing time cannot be secured.

### SUMMARY

To solve the problem described above, one aspect of a liquid crystal device according to the present disclosure provides a liquid crystal device performing at a predetermined frame rate, image writing of supplying a video signal to a pixel via a signal line, the liquid crystal device including, an inversion period setting unit configured to set an inversion period, in which a polarity of the video signal is inverted, to be a length that includes two or more frames for performing the image writing, and a pre-charge unit configured to perform, in a predetermined period from inversion of a polarity of the video signal until elapse of the inversion period, pre-charge, in which a pre-charge signal is supplied to the signal line, for a first frame but not to perform the pre-charge for at least one frame among second and subsequent frames.

### BRIEF DESCRIPTION OF THE DRAWINGS

FIG. 1 is an explanatory view of a liquid crystal device according to First Exemplary Embodiment of the present disclosure.

FIG. 2 is a block diagram illustrating a configuration of the liquid crystal device according to First Exemplary Embodiment.

FIG. 3 is a circuit diagram illustrating a configuration of a pixel.

FIG. 4 is a diagram illustrating an example of an operation timing of the liquid crystal device according to First Exemplary Embodiment.

FIG. 5 is a block diagram illustrating a configuration of a liquid crystal device according to Second Exemplary Embodiment of the present disclosure.

FIG. 6 is a diagram illustrating an example of an operation timing of the liquid crystal device according to Second Exemplary Embodiment.

FIG. 7 is a diagram illustrating another example of the operation timing of the liquid crystal device according to Second Exemplary Embodiment.

FIG. 8 is a block diagram illustrating a configuration of a liquid crystal device according to Third Exemplary Embodiment of the present disclosure.

FIG. 9 is a diagram illustrating an example of an operation timing of the liquid crystal device according to Third Exemplary Embodiment.

FIG. 10 is a perspective view illustrating a personal computer serving as one example of an electronic apparatus.

FIG. 11 is a front view illustrating a smart phone serving as one example of an electronic apparatus.

FIG. 12 is a schematic view illustrating a projection-type display apparatus serving as one example of an electronic apparatus.

### DESCRIPTION OF EXEMPLARY EMBODIMENTS

### First Exemplary Embodiment

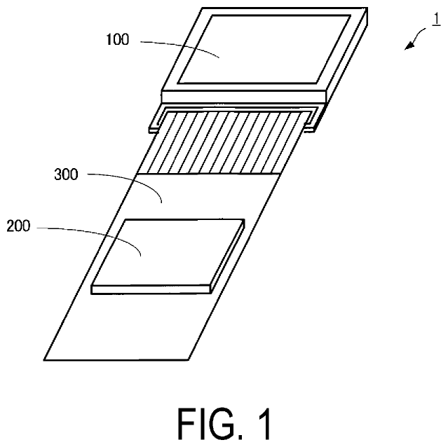

The First Exemplary Embodiment according to the present disclosure will be described with reference to FIGS. 1 to 4. FIG. 1 is an explanatory view illustrating a liquid crystal device 1 according to First Exemplary Embodiment of the present disclosure. Note that FIG. 1 illustrates a configuration of a signal transmission system for the liquid crystal device 1. The liquid crystal device 1 includes an electro-optical panel 100, a drive integrated circuit (IC) 200 such as a driver integrated circuit, and a flexible circuit board 300. The electro-optical panel 100 is, for example, a transmissive-type electro-optical device, and is coupled to the flexible circuit board 300 on which the drive integrated circuit 200 is mounted. The electro-optical panel 100 is coupled to a host central processing unit (CPU) device (not illustrated) through the flexible circuit board 300 and the drive integrated circuit 200. The drive integrated circuit 200 is a device configured to receive video data and various control signals for drive control from the host CPU device through the flexible circuit board 300, and drives the electro-optical panel 100 through the flexible circuit board 300.

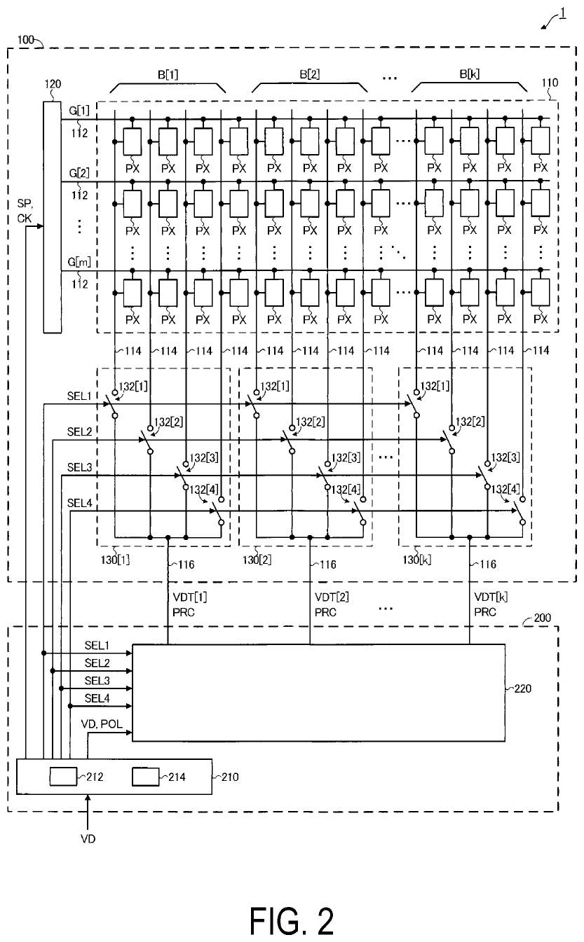

FIG. 2 is a block diagram illustrating a configuration of the electro-optical device 1 according to First Exemplary Embodiment. The electro-optical panel 100 of the liquid crystal device 1 includes a pixel unit 110, a scanning-line drive circuit 120, and k pieces of demultiplexers 130[1] to 130[k]. Note that the k represents a natural number. The drive integrated circuit 200 of the liquid crystal device 1 includes a control circuit 210 and a data-line drive circuit 220.

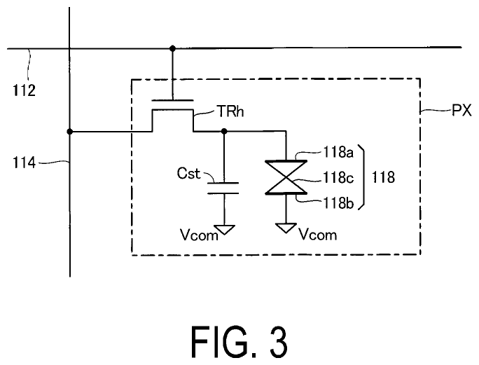

The pixel unit 110 includes pixels PX arranged to correspond to individual intersections between m lines of scanning lines 112 and n lines of signal lines 114. Note that the m and n each represent a natural number. As illustrated in FIG. 3, the pixel PX includes a liquid crystal 118c whose transmittance varies depending on the applied voltage. As a result of variation in the transmittance of the liquid crystal 118c depending on the voltage applied to the liquid crystal 118c, the display gradation of the pixel PX changes.

The scanning-line drive circuit 120 generates scanning signals G[1] to G[m] based on control signals such as the start pulse SP and the clock signal CK received from the control circuit 210, and outputs the scanning signal G[1] to G[m] to each of the m lines of scanning lines 112. One period of the clock signal CK has, for example, the same length as one horizontal scanning period for writing the video signal VDT to a single row of pixels PX. For example, the scanning-line drive circuit 120 generates the scanning signals G[1] to G[m] by shifting the start pulse SP in accordance with the clock signal CK. In other words, in the vertical scanning period, the scanning-line drive circuit 120 sequentially activates, for each horizontal scanning period, the scanning signals G[1] to G[m] corresponding to individual scanning lines 112.

For example, the scanning signal G[L], corresponding to the Lth row, is active in a period in which the scanning signal G[L] is maintained at a selected voltage such as the high level. Note that the L represents a natural number from 1 to m. In a period in which the scanning signal G[L] is active, in other words, in a period in which the scanning line 112 corresponding to the Lth row is selected, each liquid crystal 118c included in each of the n pieces of pixels PX in the Lth row is electrically coupled to the n lines of signal lines 114, respectively. Note that, when the scanning signal G[L] is not active, the electrical coupling state between each of the liquid crystals 118c included in each of the n pieces of pixels PX in the Lth row and the corresponding signal line 114 of the n lines of signal lines 114 is in a non-conduction state.

In the example illustrated in FIG. 2, the n lines of signal lines 114 in the pixel unit 110 are divided into k pieces of wiring line blocks B[1] to B[k] with four lines being a unit. Note that, when the n represents a multiple of 4, the k is a value obtained by dividing n by 4. The signal lines 114 are grouped for each wiring line block B.

The k pieces of demultiplexers 130[1] to 130[k] correspond to k pieces of wiring line blocks B[1] to B[k], respectively. For example, k pieces of demultiplexers 130[1] to 130[k] receive video signals VDT[1] to VDT[k] respectively supplied to k lines of data lines 116 from the data-line drive circuit 220. Note that, in the present exemplary embodiment, since the signal line 114 is divided with four lines being a unit, the video signals VDT for four pixels are supplied from the data-line drive circuit 220 to a single data line 116 in a time division manner. Thus, each demultiplexer 130 supplies the video signal VDT to four lines of signal lines 114 included in the corresponding wiring line block B in a time division manner.

Each demultiplexer 130 has four switches 132[1] to 132[4] respectively coupled to each of four signal lines 114 included in a corresponding wiring line block B. In other words, one contact point of each of the four switches 132[1] to 132[4] of the demultiplexer 130[i] is coupled to a corresponding signal line 114 of the four signal lines 114 included in the wiring line block B[i], where the i represents a natural number from 1 to k. In addition, the other contact point of each of the four switches 132[1] to 132[4] of the demultiplexer 130[i], that is, contact points that are not coupled to any signal line 114 are commonly coupled to a corresponding data line 116 of the k lines of data lines 116. The k lines of data lines 116 are coupled to the data-line drive circuit 220 of the drive integrated circuit 200 through the flexible circuit board 300. The switches 132[1] to 132[4] are, for example, N-channel type transistors made out of a thin film transistor (TFT) or the like, and are set to be in either a conduction state or a non-conduction state depending on the level of the selection signal SEL1 to SEL4 received at a control terminal such as a gate. Note that the switches 132[1] to 132[4] may be P-channel-type transistors or may be switching elements other than TFT.

The selection signals SEL1 to SEL4 configured to switch states of the four switches 132[1] to 132[4] of each demultiplexer 130 are supplied from the control circuit 210 of the drive integrated circuit 200 through the flexible circuit board 300. The selection signals SEL1 to SEL4 specifies a start timing for outputting the pre-charge signal PRC to the signal line 114 or a start timing for outputting the video signal VDT to the signal line 114. Here, for example, when one selection signal SEL1 is at the active level and the other three selection signals SEL2 to SEL4 are at the inactive level, only k pieces of switches 132[1] included in each of k pieces of demultiplexers 130[1] to 130[k] is in a conduction state. Thus, each of k pieces of demultiplexers 130[1] to 130[k] outputs the video signals VDT[1] to VDT[k] on k lines of data lines 116 to the first signal line 114 of each of the wiring line blocks B[1] to B[k]. Hereinafter, in a similar manner, the video signals VDT[1] to VDT[k] on k lines of data lines 116 are respectively outputted to the second, third, and fourth signal lines 114 of each of the wiring line blocks B[1] to B[k].

The control circuit 210 performs display control of the pixel unit 110 by synchronously controlling the scanning-line drive circuit 120 and the data-line drive circuit 220. For example, the control circuit 210 outputs control signals such as the start pulse SP and the clock signal CK to the scanning-line drive circuit 120, and outputs a control signal such as the selection signal SEL to the data-line drive circuit 220 to synchronously control the scanning-line drive circuit 120 and the data-line drive circuit 220.

The control circuit 210 transfers, to the data-line drive circuit 220, the video data VD inputted from an external host CPU device (not illustrated). For example, the control circuit 210 includes a frame memory (not illustrated) including a m×n bits memory space corresponding to the resolution of the pixel unit 110, and holds the video data VD inputted from the external host CPU device in frame units. Note that the control circuit 210 may have at least one line of line memory instead of the frame memory. In this case, the control circuit 210 sequentially holds the video data VD for one line in the line memory, and sequentially transfers the video data VD for one line to the data-line drive circuit 220.

Note that the liquid crystal device 1 employs a polarity inversion driving in which the polarity of the voltage applied to the liquid crystal 118c is inverted at every constant period to prevent electrical degradation of the electro-optical material such as liquid crystal 118c. In the present specification, the positive polarity represents a case in which the voltage of the video signal VDT is high voltage with respect to a predetermined voltage such as a center voltage or the like, and the negative polarity represents a case in which the voltage of the video signal VDT is low voltage with respect to the predetermined voltage.

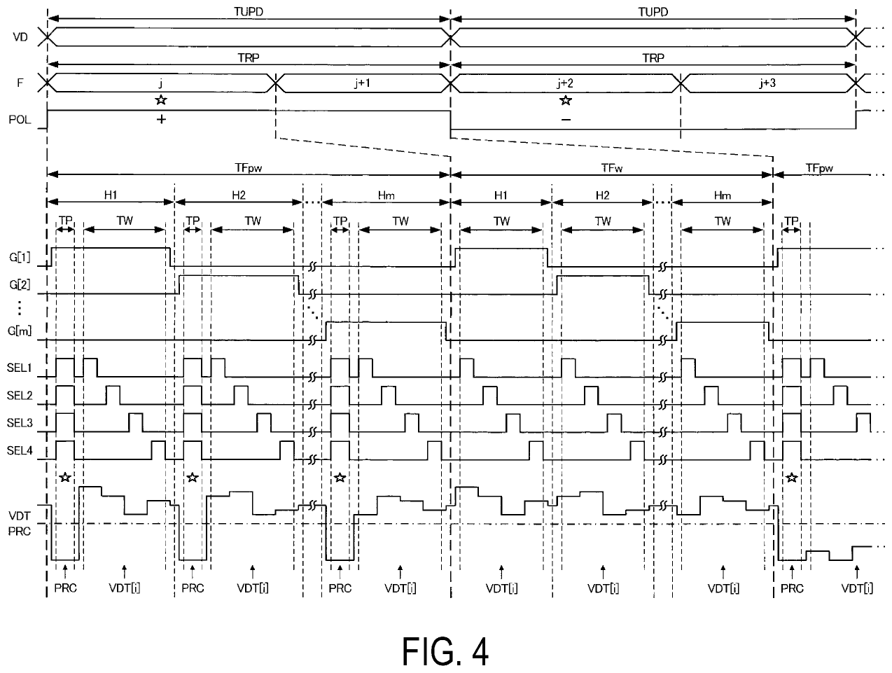

For example, the control circuit 210 includes an inversion period setting unit 212 configured to set a period in which the polarity of a video signal VDT is inverted, and a pre-charge controlling unit 214 configured to cause the data-line drive circuit 220 to perform the pre-charge for supplying the pre-charge signal PRC to the signal line 114 in accordance with the polarity inversion of the video signal VDT. Details of the operation of the inversion period setting unit 212 and the pre-charge controlling unit 214 will be described with reference to FIG. 4. The control circuit 210 outputs, to the data-line drive circuit 220, a polarity signal POL indicating the polarity of the video signal VDT, for example.

The data-line drive circuit 220 generates the video signal VDT based on the gradation defined by the video data VD supplied from the control circuit 210. Note that the polarity of the video signal VDT is set to the polarity indicated by the polarity signal POL. In other words, the data-line drive circuit 220 inverts the voltage of the video signal VDT with respect to the center voltage of the voltage of the video signal VDT in the period set by the control circuit 210. Then, the data-line drive circuit 220 outputs the video signal VDT to the signal line 114 through the demultiplexer 130 for each row of pixels to which the video signal VDT is to be written.

For example, the data-line drive circuit 220 outputs, to each of the demultiplexers 130, signals including the video signals VDT for four pixels that are supplied to four signal lines 114 coupled to each of the demultiplexers 130.

Alternatively, the data-line drive circuit 220 outputs signals including the pre-charge signal PRC and the image signals VDT for four pixels to each of the demultiplexers 130. Whether to supply the pre-charge signal PRC to the signal line 114 is set by the pre-charge controlling unit 214. Next, a configuration of the pixel PX will be described with reference to FIG. 3.

FIG. 3 is a circuit diagram illustrating a configuration of a pixel PX. Each pixel PX includes a liquid crystal element 118, a retention capacitor Cst, and a pixel transistor TRh. The liquid crystal element 118 is an electro-optical element including a pixel electrode 118a and a common electrode 118b that face each other, and also including a liquid crystal 118c disposed between the pixel electrode 118a and the common electrode 118b. The display gradation changes due to a change in the transmittance of the liquid crystal 118c according to the applied voltage across the pixel electrode 118a and the common electrode 118b. Note that a common voltage Vcom, which is a constant voltage, is supplied to the common electrode 118b through a common line (not illustrated).

The retention capacitor Cst is provided in parallel with the liquid crystal element 118. One terminal of the retention capacitor Cst is coupled to the pixel transistor TRh, and the other terminal is coupled to the common electrode 118b through a capacitance line (not illustrated).

The pixel transistor TRh is, for example, an N-channel type transistor made out of a TFT or the like, and is provided between the liquid crystal element 118 and the signal line 114. In addition, the pixel transistor TRh is set to be in either the conduction state or the non-conduction state in accordance with the level of the scanning signal G supplied to the scanning line 112 coupled to the gate. In other words, the pixel transistor TRh controls the electrical coupling between the liquid crystal element 118 and the signal line 114. For example, by setting the scanning signal G[L] to the selected voltage, the pixel transistor TRh in each pixel PX in the Lth row makes transition into a conduction state at the same time or at approximately the same time.

When the pixel transistor TRh is controlled to be in a conduction state, the video signal VDT supplied from the signal line 114 is applied to the liquid crystal element 118. The liquid crystal 118c is set to be in a transmittance based on the video signal VDT by the application of the video signal VDT. In addition, when the light source (not illustrated) is in a turned on state, light emitted from the light source is transmitted through the liquid crystal 118c of the liquid crystal element 118 included in the pixel PX, and is output to the outside of the electro-optical device 1. In other words, with the video signal VDT being applied to the liquid crystal element 118 and the light source being in the turned on state, the pixels PX implements gradation display based on the video signal VDT.

In addition, the retention capacitor Cst provided in parallel with the liquid crystal element 118 is charged to the voltage applied to the liquid crystal element 118. In other words, each pixel PX holds, in the retention capacitor Cst, a potential corresponding to the video signal VDT. Next, the operation of the liquid crystal device 1 will be described with reference to FIG. 4.

FIG. 4 is a diagram illustrating one example of an operation timing of the liquid crystal device 1 according to First Exemplary Embodiment. In the example illustrated in FIG. 4, the content of the video data VD is updated in the update period TUPD. Thus, the video signal VDT supplied to each pixel PX is also updated in the update period TUPD. In addition, in the example illustrated in FIG. 4, the averages of the frame periods TFpw and TFw are set to be one half of the update period TUPD of the video data VD. In other words, the data-line drive circuit 220 performs the image writing in which the video signal VDT is supplied to the pixel PX through the signal line 114, at a frame rate that is twice the update frequency of the video data VD. Hereinafter, the frame periods TFpw and TFw are also referred to as frame periods TF such as when the frame periods TFpw and TFw are not distinguished. Typically, the video data VD for displaying one display screen is processed on a frame-by-frame basis, and the processing period allocated to one frame F is one frame period TF. The frame period TF corresponds to a vertical scan period when the display of one frame F is performed in one vertical scan.

In the example illustrated in FIG. 4, the polarity of the video signal VDT is inverted at a frequency of one-half the frame rate. In other words, the inversion period setting unit 212 sets the inversion period TRP, which is a period in which the polarity of an image signal VDT is inverted, to be a length including two frames F where the image writing is performed in each of the frames. Note that the inversion period setting unit 212 may set the inversion period TRP to be a length including three or more frames F where the image writing is performed in each of the frames.

Furthermore, the star-shaped mark in FIG. 4 indicates that pre-charge is performed. For example, the pre-charge is a negative-polarity pre-charge for supplying the signal line 114 with a voltage lower than the center voltage of the video signal VDT and equal to or greater than the minimum voltage of the video signal VDT as the pre-charge signal PRC. The dot-dash line in FIG. 4 indicates the center voltage of the video signal VDT. In the example illustrated in FIG. 4, the pre-charge is performed on the j-th and (j+2)-th frames F, which are frames F where image writing is first performed after the polarity of the video signal VDT is inverted. Note that the j represents a natural number.

In other words, the pre-charge controlling unit 214 sets, as a target to be pre-charged, the first frame F in a predetermined period from inversion of the polarity of the video signal VDT until the inversion period TRP has elapsed, and excludes, from the target to be pre-charged, the second frame F in the predetermined period. In the example illustrated in FIG. 4, the predetermined period represents each of the periods in which the polarity signal POL is maintained to be a high level as well as a period in which the polarity signal POL is maintained to be a low level. The pre-charge controlling unit 214 notifies the data-line drive circuit 220 of the frame F to be pre-charged.

As a result, the data-line drive circuit 220 performs, in a predetermined period from inversion of the polarity of the video signal VDT until the inversion period TRP has elapsed, to the first frame F, pre-charge for supplying the pre-charge signal PRC to the signal line 114, and does not perform the pre-charge to the second frame F. Note that, when the inversion period TRP is set to be a length including three or more frames F, the pre-charge controlling unit 214 excludes at least one of the second and subsequent frames in the predetermined period from the target to be pre-charged. In other words, when the inversion period TRP is set to be a length including three or more frames F, the data-line drive circuit 220 does not perform the pre-charge for at least one of the second and subsequent frames F in the predetermined period.

Note that the data-line drive circuit 220 is an example of a pre-charge unit. The j-th and (j+2)-th frames F illustrated in FIG. 4 are each one example of the first frame F in a predetermined period, and the (j+1)-th and (j+3)-th frames F are each one example of the second frame F in a predetermined period. Next, description will be made of a supply timing of the pre-charge signal PRC and the video signal VDT in the j-th frame F where pre-charge is performed, and also be made of a supply timing of the video signal VDT in the (j+1)-th frame F where pre-charge is not performed. In FIG. 4, only the signal VDT[i] of the k pieces of picture signals VDT[1] to VDT[k] is illustrated videoto facilitate viewing the drawing. Note that the i represents a natural number from 1 to k.

In the j-th frame F, which is a frame to be pre-charged, the pre-charge period TP is allocated before the writing period TW for supplying the video signal VDT to the pixel PX through the signal line 114. For example, in the j-th frame F, the data-line drive circuit 220 outputs, to the respective demultiplexers 130, a voltage less than the center voltage of the video signal VDT and equal to or greater than the minimum voltage of the video signal VDT as the pre-charge signal PRC, in the pre-charge period TP of each of the horizontal scanning periods H1 to Hm. In the pre-charge period TP, the switches 132[1] to 132[4] of each demultiplexer 130 are set to be in a conduction state by selection signals SEL1 to SEL4 outputted from the control circuit 210. Thus, in the j-th frame F, the pre-charge signal PRC is supplied to all of the signal lines 114 in the pre-charge period TP of each of the horizontal scanning periods H1 to Hm. As a result, the pre-charge signal PRC is supplied to the pixel PX through the signal line 114 for each row of pixels to which the video signal VDT is written.

In the j-th frame F, the data-line drive circuit 220 supplies the positive-polarity video signal VDT to the pixels PX through the signal line 114, in the writing period TW of each of the horizontal scanning periods H1 to Hm. For example, in the writing period TW, the data-line drive circuit 220 outputs, to each demultiplexer 130, signals including video signals VDT for four pixels respectively supplied to four signal lines 114 coupled to each demultiplexer 130.

In the writing period TW, the switches 132[1] to 132[4] of each demultiplexer 130 are set sequentially to be in the conduction state by the selection signals SEL1 to SEL4 outputted from the control circuit 210. Thus, in the writing period TW, the video signals VDT for four pixels supplied to each demultiplexer 130 are outputted to the signal lines 114 in a time series manner using the switches 132[1] to 132[4].

For example, in the case of the video signal VDT[i] outputted to the demultiplexer 130[i], video signals VDT for four pixels that are respectively supplied to four signal lines 114 coupled to the demultiplexer 130[i] are subjected to time-division multiplex. Thus, in accordance with the selection signals SEL1 to SEL4 outputted from the control circuit 210, the demultiplexer 130[i] performs time division demultiplexing on the video signal VDT[i], and outputs the video signals VDT for four pixels to the signal lines 114 in a time series manner.

In the (j+1)-th frame F in which no pre-charge is performed, the pre-charge period TP is not allocated. Thus, in the (j+1)-th frame F, the data-line drive circuit 220 supplies the positive-polarity video signal VDT to the pixels PX through the signal line 114 in the writing period TW of each of the horizontal scanning periods H1 to Hm. The operation of the liquid crystal device 1 in the (j+1)-th frame F is similar to that in the j-th frame F except that pre-charge is not performed, and hence, detailed descriptions thereof will be omitted. The operation of the liquid crystal device 1 in the (j+2)-th and (j+3)-th frames F is similar to that in the j-th and (j+1)-th frames F, respectively, except that the polarity of the video signal VDT is negative. In other words, in the frame F to be pre-charged, the negative-polarity pre-charge is performed regardless of the polarity of the video signal VDT.

The frame period TFw corresponding to the (j+1)-th frame F is shorter than the frame period TFpw corresponding to the j-th frame F because pre-charge is not performed in the frame period TFw. Note that, the writing period TW has the same length for the j-th frame F and the (j+1)-th frame F. Thus, in the liquid crystal device 1, the writing period TW can be longer than a case where the pre-charge is performed in all of the frames F.

For example, when pre-charge is performed in all of the frames F, the pre-charge period TP needs to be secured in each of the horizontal scanning periods H1 to Hm even in the (j+1)-th frame F. Thus, the writing period in the case where the pre-charge is performed in all of the frames F reduces, as compared with the writing period TW. As a result, when the frame rate increases in the case where pre-charge is performed in all of the frames F, it is difficult to secure the writing time for writing the video signal VDT to the pixels PX.

In contrast, in a case of the liquid crystal device 1, the pre-charge is performed in accordance with inversion of the polarity of the video signal VDT, and hence, the writing period TW can be set to be longer than that in the case where the pre-charge is performed in all of the frames F. Thus, the liquid crystal device 1 can ensure a writing time even when the frame rate increases.

Furthermore, the present inventor has confirmed through experiments or the like that, by performing a negative-polarity pre-charge in a frame F immediately after the polarity of the video signal VDT is inverted regardless of the polarity of the video signal VDT, the quality of display image improves, as compared with a case where no negative-polarity pre-charge is performed in a frame F immediately after the polarity of the video signal VDT is inverted. For example, by performing the negative-polarity pre-charge, leakage of the pixel transistor TRh and the like are suppressed, and pixel unevenness, vertical crosstalk, vertical brightness unevenness in the screen, and the like are reduced. This results in an improvement of the image quality of the displayed image.

Thus, in a case of the liquid crystal device 1 that performs the negative-polarity pre-charge in accordance with inversion of the polarity of the video signal VDT, it is possible to sufficiently obtain an effect of improving the image quality using pre-charge, as compared with a case where the negative-polarity pre-charge is omitted in a frame F immediately after the polarity of the video signal VDT is inverted. In other words, the liquid crystal device 1 can ensure a writing time while obtaining the effect using pre-charge even when the frame rate increases to improve the image quality of the displayed image.

As described above, in First Exemplary Embodiment, the inversion period setting unit 212 sets the inversion period TRP in which the polarity of the video signal VDT is inverted, to be a length including two or more frames F where the image writing is performed in each of the frames. In addition, the data-line drive circuit 220 that functions as a pre-charge unit is configured to perform, in a predetermined period from inversion of the polarity of the video signal VDT until the inversion period TRP has elapsed, to a first frame F, pre-charge for supplying a pre-charge signal PRC to the signal line 114 and not perform the pre-charge to at least one frame among a second and subsequent frames F.

In the liquid crystal device 1, the image quality of the displayed image can be improved using the pre-charge performed in accordance with inversion of the polarity of the video signal VDT. In addition, in the liquid crystal device 1, since the pre-charge is not performed to at least one of frames F having the same polarity of the video signal VDT as that of the previous frame F, the writing period TW can be longer, as compared with a case in which pre-charge is performed in all of the frames F. As a result, the writing time can be ensured even when the frame rate is increased to improve the image quality of the displayed image. In other words, the liquid crystal device 1 can secure a write time while obtaining the effect using pre-charge even when the frame rate increases.

### Second Exemplary Embodiment

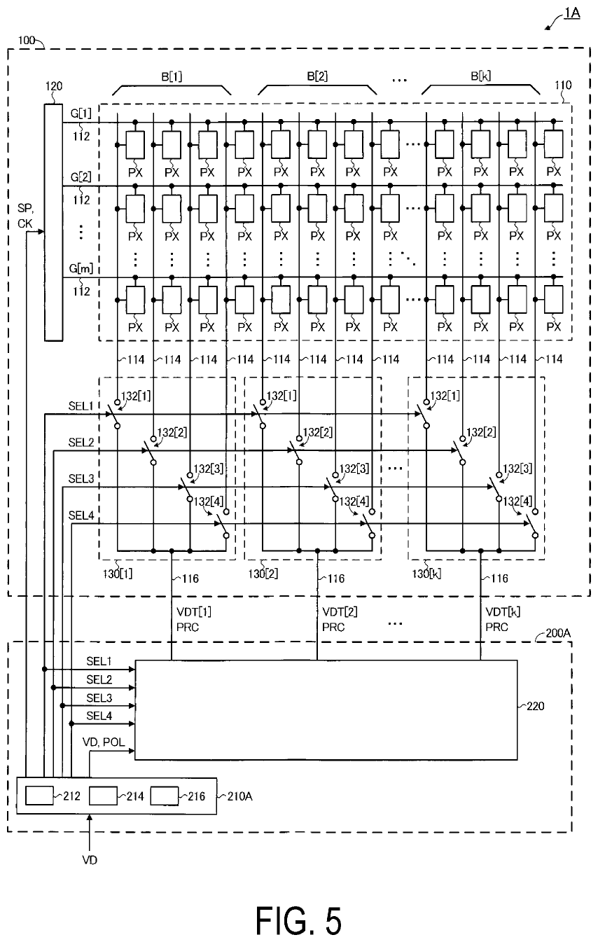

FIG. 5 is a block diagram illustrating the configuration of a liquid crystal device 1A according to Second Exemplary Embodiment of the present disclosure. The liquid crystal device 1A according to Second Exemplary Embodiment is the same as the liquid crystal device 1 according to First Exemplary Embodiment, except that a frame-rate setting unit 216 is added. Elements that are the same as those described with reference to FIGS. 1 to 4 are denoted as the same reference characters, and detailed descriptions thereof are omitted. The liquid crystal device 1A is the same as the liquid crystal device 1 in FIG. 1 except that the liquid crystal device 1A includes a drive integrated circuit 200A, instead of the drive integrated circuit 200 in FIG. 1. For example, the liquid crystal device 1A includes the electro-optical panel 100, the drive integrated circuit 200A, and the flexible circuit board 300 in FIG. 1.

The electro-optical panel 100 is the same as the electro-optical panel 100 in FIG. 2. In other words, the electro-optical panel 100 includes the pixel unit 110, the scanning-line drive circuit 120, and k pieces of demultiplexers 130[1] to 130[k]. The drive integrated circuit 200A is the same as the drive integrated circuit 200 in FIG. 2, except that the drive integrated circuit 200A includes a control circuit 210A instead of the control circuit 210 in FIG. 2. In other words, the drive integrated circuit 200A includes the control circuit 210A and the data-line drive circuit 220. The data-line drive circuit 220 is the same as the data-line drive circuit 220 in FIG. 2.

The control circuit 210A is the same as the control circuit 210 in FIG. 2, except that the frame-rate setting unit 216 is added to the control circuit 210 in FIG. 2. In other words, the control circuit 210A includes an inversion period setting unit 212, a pre-charge controlling unit 214, and the frame-rate setting unit 216. The inversion period setting unit 212 and the pre-charge controlling unit 214 are the same as the inversion period setting unit 212 and the pre-charge controlling unit 214 in FIG. 2.

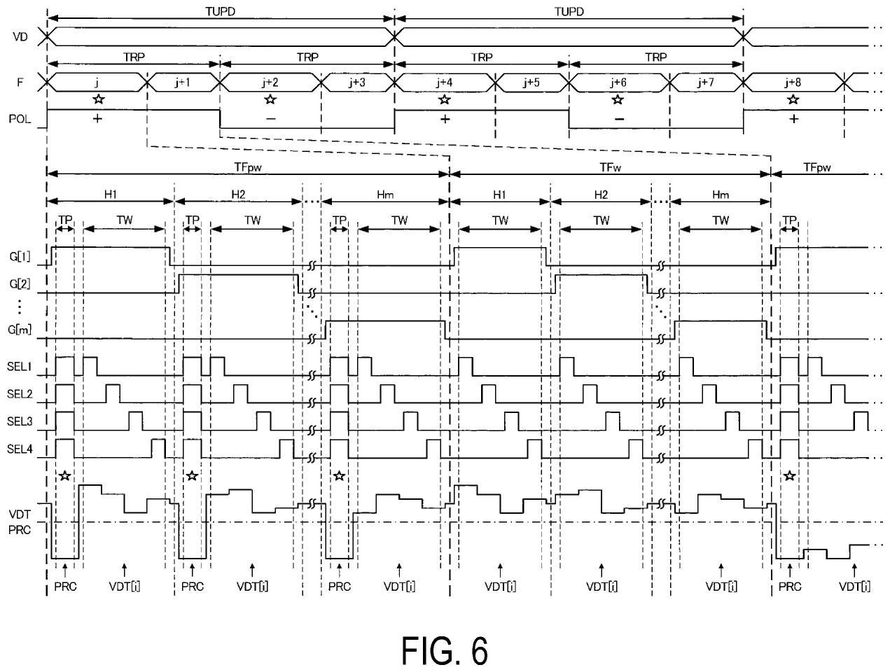

The frame-rate setting unit 216 sets the frame rate at the time of performing image writing in which the video signal VDT is supplied to the pixel PX through the signal line 114, to be a frame rate at which the number of frames F where image writing is performed in each of the frames is equal to or more than two frames for each update period TUPD of the video signal VDT. In the example illustrated in FIG. 6, the frame-rate setting unit 216 sets the frame rate at the time of performing image writing, to be a frame rate at which the number of the frames F where image writing is performed in each of the frames is four frames for each update period TUPD.

FIG. 6 is a diagram illustrating an example of an operation timing of the liquid crystal device 1A according to Second Exemplary Embodiment. In the example illustrated in FIG. 6, the averages of the frame periods TFpw and TFw are each set to a quarter of the update period TUPD of the video data VD. In other words, the frame-rate setting unit 216 sets the frame rate at the time of performing the image writing, to be four times the updated frequency of the video data VD. Thus, the data-line drive circuit 220 performs the image writing to the frame F at a frame rate that is four times the update frequency of the video data VD.

Furthermore, in the example illustrated in FIG. 6, the polarity of the video signal VDT is inverted at a frequency of one-half the frame rate. In other words, the inversion period setting unit 212 sets the inversion period TRP in which the polarity of the video signal VDT is inverted, to be a length including two frames F where the image writing is performed in each of the frames.

Furthermore, the meaning of the star-shaped mark and the dot-dash line in FIG. 6 is the same as the star-shaped mark and the dot-dash line in FIG. 4. In the example illustrated in FIG. 6, the negative-polarity pre-charge is performed for the j-th, (j+2)-th, (j+4)-th, (j+6)-th, and (j+8)-th frames F in which the image writing is performed first after the polarity of the video signal VDT is inverted. The j-th, (j+2)-th, (j+4)-th, and (j+6)-th frames F illustrated in FIG. 6 are examples of the first frame F in a predetermined period from inversion of the polarity of the video signal VDT until the inversion period TRP has elapsed. In addition, the (j+1)-th, (j+3)-th, (j+5)-th, and (j+7)-th frames F illustrated in FIG. 6 are examples of the second frame F in the predetermined period.

The operation of the liquid crystal device 1A in the j-th, (j+4)-th, and (j+8)-th frames F is similar to the operation of the liquid crystal device 1 in the j-th frame F in FIG. 4. The operation of the liquid crystal device 1A in the (j+2)-th and (j+6)-th frames F is similar to the operation of the liquid crystal device 1 in the j-th frame F in FIG. 4, except that the polarity of the video signal VDT is negative.

The operation of the liquid crystal device 1A in the (j+1)-th and (j+5)-th frames F is similar to the operation of the liquid crystal device 1 in the (j+1)-th frame F in FIG. 4. In addition, the operation of the liquid crystal device 1A in the (j+3)-th and (j+7)-th frames F is similar to the operation of the liquid crystal device 1 in the (j+1)-th frame F in FIG. 4, except that the polarity of the video signal VDT is negative.

In other words, the data-line drive circuit 220 performs, in a predetermined period from inversion of the polarity of the video signal VDT until the inversion period TRP has elapses, to the first frame F, pre-charge for supplying the pre-charge signal PRC to the signal line 114, and does not perform the pre-charge to the second frame F.

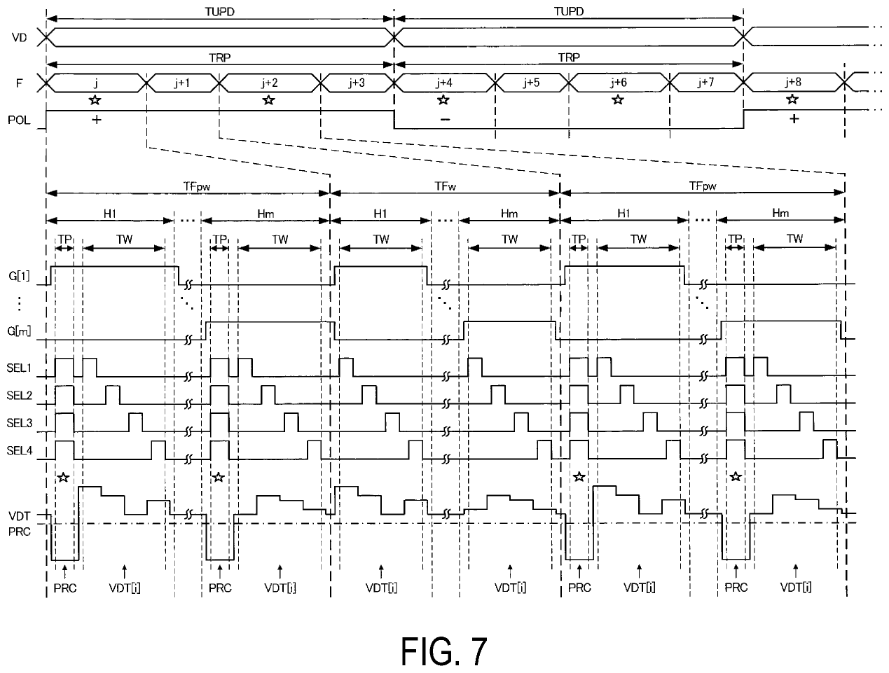

FIG. 7 is a diagram illustrating another example of the operation timing of the liquid crystal device 1A according to Second Exemplary Embodiment. In the example illustrated in FIG. 7, the inversion period TRP in which the polarity of the video signal VDT is inverted, differs in the operation timing from FIG. 6. For example, in the operation timing in FIG. 7, the polarity of the video signal VDT is inverted at a frequency of one quarter of the frame rate. In other words, in the example illustrated in FIG. 7, the inversion period setting unit 212 sets the inversion period TRP in which the polarity of the video signal VDT is inverted, to be a length including four frames F where the image writing is performed in each of the frames. Note that the frame rate at the time of performing the image writing is set to be four times the update frequency of the video data VD, as with the operation timing in FIG. 6.

Furthermore, the meaning of the star-shaped mark and the dot-dash line in FIG. 7 is the same as the star-shaped mark and the dot-dash line in FIG. 6. In the example illustrated in FIG. 7, the negative-polarity pre-charge is performed to a frame F where image writing is performed first after the polarity of the video signal VDT is inverted, and also to a frame F where image writing is performed third after the polarity of the video signal VDT is inverted.

For example, the frame F where image writing is performed first after the polarity of the video signal VDT is inverted includes the j-th, (j+4)-th, and (j+8)-th frames F, and the frame F where image writing is performed third after the polarity of the video signal VDT is inverted includes the (j+2)-th and (j+6)-th frames F. Note that the frame F where image writing is performed second after the polarity of the video signal VDT is inverted includes the (j+1)-th and (j+5)-th frames F, and the frame F where image writing is performed fourth after the polarity of the video signal VDT is inverted includes the (j+3)-th and (j+7)-th frames F.

The j-th, (j+4)-th, and (j+8)-th frames F illustrated in FIG. 7 are examples of the first frame F in a predetermined period from inversion of the polarity of the video signal VDT until the inversion period TRP has elapsed. In addition, the (j+1)-th, (j+2)-th, (j+3)-th, (j+5)-th, (j+6)-th, and (j+7)-th frames F illustrated in FIG. 7 are examples of the second and subsequent frames F in the predetermined period.

The operation of the liquid crystal device 1A in the j-th, (j+2)-th, and (j+8)-th frames F is similar to that in the j-th frame F in FIG. 6. The operation of the liquid crystal device 1A in the (j+4)-th and (j+6)-th frames F is similar to that in the (j+2)-th frame F in FIG. 6. The operation of the liquid crystal device 1A in the (j+1)-th and (j+3)-th frames F is similar to that in the (j+1)-th frame F in FIG. 6. The operation of the liquid crystal device 1A in the (j+5)-th and (j+7)-th frames F is similar to that in the (j+3)-th frame F in FIG. 6.

In other words, the pre-charge controlling unit 214 sets, as the target to be pre-charged, the first frame F and the third frame F in a predetermined period from inversion of the polarity of the video signal VDT until the inversion period TRP has elapsed. The pre-charge controlling unit 214 excludes, from the target to be pre-charged, the second and fourth frames F in the predetermined period. The pre-charge controlling unit 214 notifies the data-line drive circuit 220 of a frame F serving as the target to be pre-charged.

As a result, the data-line drive circuit 220 performs, in a predetermined period from inversion of the polarity of the video signal VDT until the inversion period TRP has elapsed, to the first frame F and the third frame F, pre-charge for supplying the pre-charge signal PRC to the signal line 114. In addition, the data-line drive circuit 220 does not perform the pre-charge to the second and fourth frames F in the predetermined period. In other words, the data-line drive circuit 220 does not perform the pre-charge to at least one of the second and subsequent frames F in the predetermined period.

As described above, also in Second Exemplary Embodiment, it is possible to obtain effects similar to those obtained in First Exemplary Embodiment. For example, the data-line drive circuit 220 performs, in a predetermined period including three or more frames F, negative-polarity pre-charge to the first frame F and the third frame F, and does not perform pre-charge to the second frame F. In this way, since the liquid crystal device 1A does not perform pre-charge to at least one of the second and subsequent frames in a predetermined period, it is possible to secure a write time while obtaining the effect using pre-charge even when the frame rate is increased to improve the image quality of the displayed image.

In addition, the liquid crystal device 1A includes the frame-rate setting unit 216 configured to set the frame rate at the time of performing image writing, to be a frame rate at which the number of the frames F where image writing is performed in each of the frames is two or more for each update period TUPD of the video signal VDT. Thus, in a case of the liquid crystal device 1A, by setting the frame rate at the time of performing image writing, to be twice or more times the update frequency of the video signal VDT, it is possible to reduce the amount of charge, which leaks from the pixel PX, per update period TUPD, as compared with a case where the frame rate is the same as the update frequency of the video signal VDT.

### Third Exemplary Embodiment

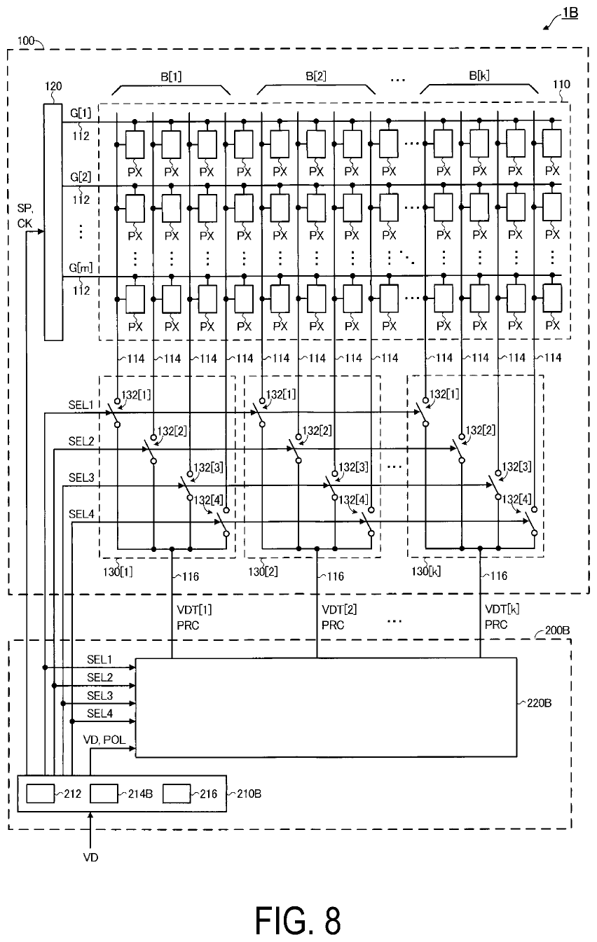

FIG. 8 is a block diagram illustrating a configuration of a liquid crystal device 1B according to Third Exemplary Embodiment of the present disclosure. The liquid crystal device 1B according to Third Exemplary Embodiment is the same as the liquid crystal device 1A according to Second Exemplary Embodiment, except that supplementary pre-charge is performed to the first frame in a positive polarity period. The positive polarity period is a predetermined period from inversion of the polarity of the video signal VDT from the negative polarity to the positive polarity, and until the inversion period TRP has elapsed. The supplementary pre-charge is a pre-charge that, after performing the negative-polarity pre-charge, supplies the voltage equal to or greater than the center voltage of the video signal VDT and equal to or less than the maximum voltage of the video signal VDT to the signal line 114 as the pre-charge signal PRC.

Elements that are the same as those described with reference to FIGS. 1 to 7 are denoted as the same reference characters, and detailed descriptions thereof will be omitted. The liquid crystal device 1B is the same as the liquid crystal device 1A in FIG. 5, except that the liquid crystal device 1B includes a drive integrated circuit 200B instead of the drive integrated circuit 200A in FIG. 5. For example, the liquid crystal device 1B includes the electro-optical panel 100, the drive integrated circuit 200B, and the flexible circuit board 300 in FIG. 1.

The electro-optical panel 100 is the same as the electro-optical panel 100 in FIG. 5. In other words, the electro-optical panel 100 includes the pixel unit 110, the scanning-line drive circuit 120, and k pieces of demultiplexers 130[1] to 130[k]. The drive integrated circuit 200B is the same as the drive integrated circuit 200A in FIG. 5, except that the drive integrated circuit 200B includes a control circuit 210B and a data-line drive circuit 220B, instead of the control circuit 210A and the data-line drive circuit 220, respectively, in FIG. 5. In other words, the drive integrated circuit 200B includes the control circuit 210B and the data-line drive circuit 220B.

The control circuit 210B is the same as the control circuit 210A in FIG. 5, except that the control circuit 210B includes a pre-charge controlling unit 214B instead of the pre-charge controlling unit 214 in FIG. 5. In other words, the control circuit 210B includes the inversion period setting unit 212, the pre-charge controlling unit 214B, and the frame-rate setting unit 216. The inversion period setting unit 212 and the frame-rate setting unit 216 are the same as the inversion period setting unit 212 and the frame-rate setting unit 216 in FIG. 5.

The pre-charge controlling unit 214B is the same as the pre-charge controlling unit 214 in FIG. 5, except that the first frame F in the positive polarity period is set to be the target of supplementary pre-charge. For example, the pre-charge controlling unit 214 notifies the data-line drive circuit 220B of a frame F to be subjected to negative-polarity pre-charge and a frame F serving as the target of supplementary pre-charge.

The data-line drive circuit 220B is the same as the data-line drive circuit 220 in FIG. 5, except that supplementary pre-charge is performed after performing the negative-polarity pre-charge based on control from the control circuit 210B. For example, the data-line drive circuit 220B performs, in a positive-polarity period that is a predetermined period from inversion of the polarity of the video signal VDT from the negative polarity to the positive polarity until the inversion period TRP has elapsed, to the first frame F, supplementary pre-charge for supplying a voltage equal to or greater than the center voltage of the video signal VDT and equal to or less than the maximum voltage of the video signal VDT to the signal line 114 as the pre-charge signal PRC after performing negative-polarity pre-charge. Note that the data-line drive circuit 220B is an example of a pre-charge unit.

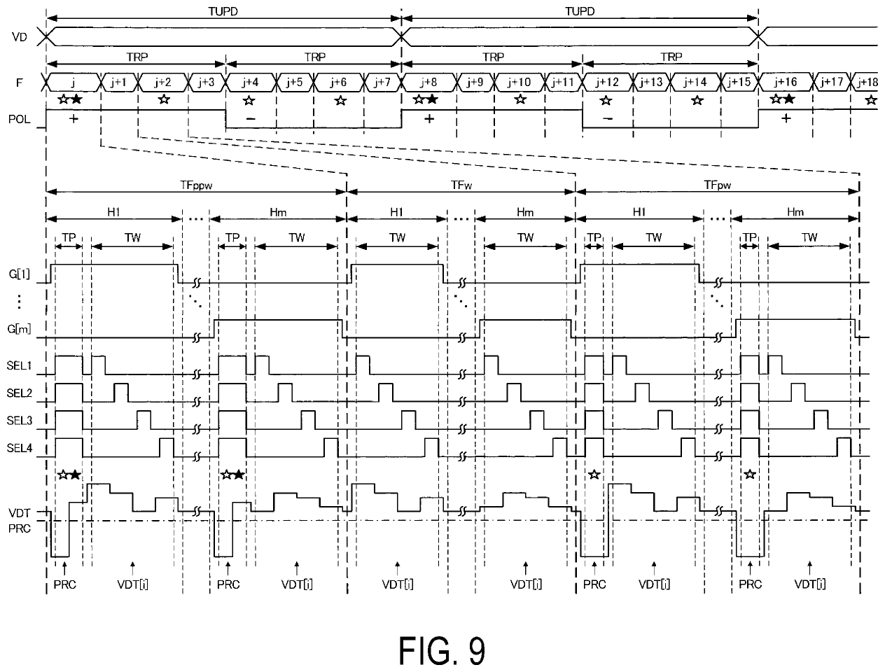

FIG. 9 is a diagram illustrating an example of an operation timing of the liquid crystal device 1B according to Third Exemplary Embodiment. In FIG. 9, the frame periods TFppw, TFpw, and TFw are also referred to as frame periods TF, such as when the frame periods TFppw, TFpw, and TFw are not distinguished. In the example illustrated in FIG. 9, the frame-rate setting unit 216 sets the frame rate at the time of writing an image, to be a frame rate at which the number of the frames F where image writing is performed in each of the frames is eight frames for each update period TUPD. For example, the average of frame periods TF of eight frames F in each update period TUPD is set to be one eighth of the update period TUPD of the video data VD. In other words, the frame-rate setting unit 216 sets the frame rate at the time of writing an image to be eight times the update frequency of the video data VD. Thus, the data-line drive circuit 220B performs the image writing to a frame F at a frame rate that is eight times the update frequency of the video data VD.

In the example illustrated in FIG. 9, the polarity of the video signal VDT is inverted at a frequency of one quarter of the frame rate. In other words, the inversion period setting unit 212 sets the inversion period TRP in which the polarity of the video signal VDT is inverted, to be a length including four frames F where the image writing is performed in each of the frames. The black star-shaped mark in FIG. 9 indicates that supplementary pre-charge is performed. Note that the meaning of the white star-shaped mark and the dot-dash line in FIG. 9 is the same as the star-shaped mark and the dot-dash line in FIG. 7.

The pre-charge controlling unit 214B sets, as the target of the negative-polarity pre-charge, the first frame F and the third frame F in a predetermined period from inversion of the polarity of the video signal VDT until the inversion period TRP has elapsed. Furthermore, the pre-charge controlling unit 214B sets, as the target of supplementary pre-charge, the first frame F in the positive polarity period, which is a predetermined period from inversion of the polarity of the video signal VDT from the negative polarity to the positive polarity until the inversion period TRP has elapsed. In other words, the j-th, (j+8)-th, and (j+16)-th frames F, which are frames F where image writing is first performed after the polarity of the video signal VDT is inverted from the negative polarity to the positive polarity, are set as the target of negative-polarity pre-charge and supplementary pre-charge. In the example illustrated in FIG. 9, the positive polarity period, which is a predetermined period from inversion of the polarity of the video signal VDT from the negative polarity to the positive polarity until the inversion period TRP has elapsed, is the period in which the polarity signal POL is maintained at a high level. Note that the predetermined period also includes the period in which the polarity signal POL is maintained at a low level.

The pre-charge controlling unit 214B excludes, from the target to be pre-charged, the second and fourth frames F in the predetermined period. Then, the pre-charge controlling unit 214B notifies the data-line drive circuit 220B of the frame F serving as the target of the negative-polarity pre-charge and the frame F serving as the target of the supplementary pre-charge.

As a result, the data-line drive circuit 220B performs, in a predetermined period from inversion of the polarity of the video signal VDT until the inversion period TRP has elapsed, negative-polarity pre-charge to the first frame F and the third frame F, and does not perform pre-charge to the second and fourth frames F. In addition, in the positive polarity period, the data-line drive circuit 220B performs supplementary pre-charge after performing the negative-polarity pre-charge to the first frame F, and does not perform supplementary pre-charge to the third frame F. Next, description will be made of the supply timing of the pre-charge signal PRC and the video signal VDT in the j-th frame F in which negative-polarity pre-charge and supplementary pre-charge are performed.

In the j-th frame F, the data-line drive circuit 220B outputs, to each demultiplexer 130, a first voltage less than the center voltage of the video signal VDT and equal to or greater than the minimum voltage of the video signal VDT as the pre-charge signal PRC, in the pre-charge period TP of each of the horizontal scanning periods H1 to Hm. In the pre-charge period TP, the switches 132[1] to 132[4] of each demultiplexer 130 are set to be in a conduction state according to the selection signal SEL1 to SEL4 outputted from the control circuit 210. Thus, in the j-th frame F, the pre-charge signal PRC having the first voltage is supplied to all of the signal lines 114 in the pre-charge period TP of each of the horizontal scanning periods H1 to Hm. As a result, the pre-charge signal PRC having the first voltage is supplied to the pixel PX through the signal line 114 for each row of pixels to which the video signal VDT is to be written.

Then, in the pre-charge period TP, the data-line drive circuit 220B outputs, to each demultiplexer 130, after a predetermined period has elapsed since the first voltage is output to each demultiplexer 130 as the pre-charge signal PRC, a second voltage equal to or greater than the center voltage of the video signal VDT and equal to or less than the maximum voltage of the video signal VDT as a pre-charge signal PRC. In other words, in the j-th frame F, in the pre-charge period TP of each of the horizontal scanning periods H1 to Hm, after the predetermined period has elapsed since the pre-charge signal PRC having the first voltage has been supplied to all of the signal lines 114, the pre-charge signal PRC having the second voltage is supplied to all of the signal lines 114. As a result, the signal line 114 is pre-charged to a second voltage that is closer to the image signal VDT having a positive polarity than the first voltage.

Furthermore, in the j-th frame F, the data-line drive circuit 220B supplies the positive-polarity video signal VDT to the pixels PX through the signal line 114 in the writing period TW of each of the horizontal scanning periods H1 to Hm, as with the operation timing in FIG. 7. In a case of the liquid crystal device 1B, supplementary pre-charge is performed in the j-th frame F, and thus, it is possible to reduce the insufficient writing of the positive-polarity video signal VDT to the pixels PX, as compared with a case where supplementary pre-charge is not performed.

Note that the operation of the liquid crystal device 1B in the (j+2)-th, (j+10)-th, and (j+18)-th frames F in which only the negative-polarity pre-charge of the negative-polarity pre-charge and the supplementary pre-charge is performed, is similar to the operation of the liquid crystal device 1A in the j-th frame F in FIG. 7. Furthermore, the operation of the liquid crystal device 1B in the (j+4)-th, (j+6)-th, (j+12)-th, and (j+14)-th frames F in which only the negative-polarity pre-charge of the negative-polarity pre-charge and the supplementary pre-charge is performed, is similar to the operation of the liquid crystal device 1A in the (j+4)-th frame F in FIG. 7. In addition, the operation of the liquid crystal device 1B in the (j+1)-th, (j+3)-th, (j+9)-th, (j+11)-th, and (j+17)-th frames F in which neither the negative-polarity pre-charge nor the supplementary pre-charge is performed, is similar to the operation of the liquid crystal device 1A in the (j+1)-th frame F in FIG. 7. Moreover, the operation of the liquid crystal device 1B in the (j+5)-th, (j+7)-th, (j+13)-th, and (j+15)-th frames F in which neither the negative-polarity pre-charge nor the supplementary pre-charge is performed, is similar to the operation of the liquid crystal device 1A in the (j+5)-th frame F in FIG. 7.

In the example illustrated in FIG. 9, the pre-charge period TP of the frame F to which the negative-polarity pre-charge and the supplementary pre-charge are performed is longer than the pre-charge period TP of the frame F to which only the negative-polarity pre-charge of the negative-polarity pre-charge and the supplementary pre-charge is performed. Thus, the frame period TFppw of the frame F to which the negative-polarity pre-charge and the supplementary pre-charge are performed is longer than the frame period TFpw of the frame F to which only the negative-polarity pre-charge of the negative-polarity pre-charge and the supplementary pre-charge is performed.

The frame period TFw of the frame F to which neither the negative-polarity pre-charge nor the supplementary pre-charge is performed is shorter than the frame period TFppw and the frame period TFpw.

Note that the writing period TW has the same length in all of the frames F, as in First Exemplary Embodiment and Second Exemplary embodiment. Thus, similar to First Exemplary Embodiment and Second Exemplary Embodiment, in the case of the liquid crystal device 1B, the writing period TW can be increased, as compared with a case where the negative-polarity pre-charge is performed in all of the frames F.

As described above, also in Third Exemplary Embodiment, it is possible to obtain effects similar to those obtained in First Exemplary Embodiment and Second Exemplary Embodiment. For example, when the frame rate is increased to improve the image quality of the displayed image, the liquid crystal device 1B can secure a writing time while obtaining the effect using pre-charge. In addition, in the case of the liquid crystal device 1B, the data-line drive circuit 220B that functions as the pre-charge unit performs supplementary pre-charge to the first frame in a positive polarity period after performing the negative-polarity pre-charge. With the supplementary pre-charge, the signal line 114 is pre-charged to a voltage equal to or greater than the center voltage of the video signal VDT and equal to or less than the maximum voltage of the video signal VDT, and hence, it is possible to reduce insufficient writing of the positive-polarity video signal VDT to the pixel PX, as compared with a case where supplementary pre-charge is not performed.

In addition, for example, in a predetermined period including three or more frames F, the data-line drive circuit 220B performs negative-polarity pre-charge to the first frame F and the third frame F, and does not perform the pre-charge to the second frame F. Furthermore, in the positive polarity period, the data-line drive circuit 220B performs supplementary pre-charge to the first frame F after performing the negative-polarity pre-charge, and does not perform supplementary pre-charge to the third frame F. When supplementary pre-charge is not performed to the third frame F in the positive polarity period, it is possible to reduce the pre-charge period TP of the third frame F in the positive polarity period, as compared with a case where both the negative-polarity pre-charge and the supplementary pre-charge are performed to the third frame F in the positive polarity period. By reducing the pre-charge period TP of the third frame F in the positive polarity period, it is possible to increase the writing period TW. In other words, for example, the liquid crystal device 1B can increase the frame rate to improve the image quality of the displayed image, and also can secure a writing time even when supplementary pre-charge is performed.

### Modification Examples

Each of the embodiments of First Exemplary Embodiment to Third Exemplary Embodiment may be variously modified. Specific modification modes are exemplified below. Any two or more modes selected from exemplifications described below may be combined as appropriate provided that mutual contradiction does not arise.

### Modified Example 1

In each form in First Exemplary Embodiment and Second Exemplary Embodiment, the data-line drive circuit 220 may perform supplementary pre-charge to the first frame F in the positive polarity period such as the j-th frame F in FIG. 4, after performing the negative-polarity pre-charge. In this case, it is also possible to obtain effects similar to those of First Exemplary Embodiment to Third Exemplary Embodiment.

### Modified Example 2

In Second Exemplary Embodiment, the data-line drive circuit 220 may perform pre-charge only to the first frame F of the plurality of frames F included in a predetermined period. In this case, for example, the data-line drive circuit 220 does not perform pre-charge to the (j+2)-th or (j+6)-th frame F in FIG. 7. In the case of Modified Example 2, it is also possible to obtain effects similar to those in Second Exemplary Embodiment.

### Modified Example 3

In Third Exemplary Embodiment, the data-line drive circuit 220B may perform negative-polarity pre-charge only to the first frame F of the plurality of frames F included in a predetermined period. In this case, for example, the data-line drive circuit 220B performs negative-polarity pre-charge only to the first frame F of the plurality of frames F included in a predetermined period, and after performing negative-polarity pre-charge, the data-line drive circuit 220B further performs supplementary pre-charge only to the first frame F of the plurality of frames F included in a positive polarity period. In the case of Modified Example 3, it is possible to obtain effects similar to those in Third Exemplary Embodiment.

### Modified Example 4

In each embodiment in First Exemplary Embodiment to Third Exemplary Embodiment, the negative-polarity pre-charge performed to the plurality of frames F included in a predetermined period may be performed at intervals other than every other frame F. In the case of Modified Example 4, it is also possible to obtain effects similar to those obtained with each form in First Exemplary Embodiment to Third Exemplary Embodiment.

### Modified Example 5

In each embodiment in First Exemplary Embodiment to Third Exemplary Embodiment, the electro-optical panel 100 may be a reflection-type electro-optical device. In addition, when the electro-optical panel 100 employs a reflection type, the electro-optical panel 100 may be a liquid crystal on silicon (LCOS) type using a semiconductor substrate for the element substrate on which the signal line 114 and the like are formed.

### Application Examples

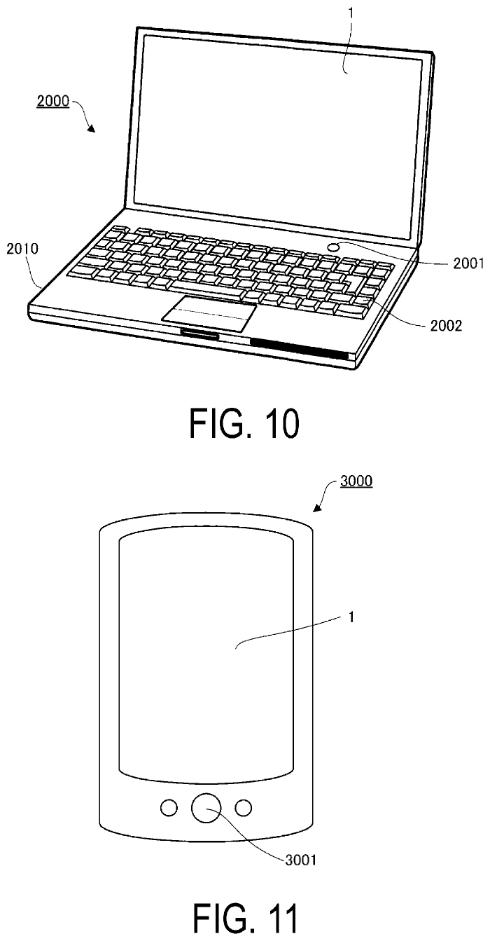

The present disclosure can be used in various electronic devices. FIGS. 10 to 12 illustrate examples of specific embodiments of electronic apparatuses to which the present disclosure is applied.

FIG. 10 is a perspective view illustrating a personal computer 2000 serving as one example of an electronic apparatus. The personal computer 2000 includes the electro-optical device 1 configured to display various images, and a main body unit 2010 in which a power source switch 2001 and a keyboard 2002 are installed. Note that, instead of the liquid crystal device 1, the personal computer 2000 may include the liquid crystal device 1A or the liquid crystal device 1B.

FIG. 11 is a front view illustrating a smartphone 3000, which is an example of the electronic apparatus. The smartphone 3000 has an operation button 3001 and the liquid crystal device 1 that displays various images. The screen content displayed on the liquid crystal device 1 is changed in accordance with the operation of the operation button 3001. Note that the smartphone 3000 may include the liquid crystal device 1A or the liquid crystal device 1B, instead of the liquid crystal device 1.

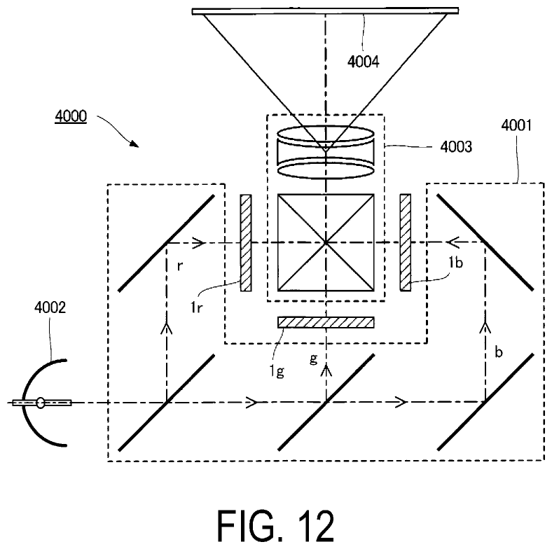

FIG. 12 is a schematic view illustrating a projection-type display apparatus 4000 serving as one example of an electronic apparatus. The projection-type display device 4000 is a three-plate type projector, for example. A liquid crystal device 1r illustrated in FIG. 12 is a liquid crystal device 1 corresponding to a red display color. A liquid crystal device 1g is a liquid crystal device 1 corresponding to a green display color. A liquid crystal device 1b is a liquid crystal device 1 corresponding to a blue display color.

In other words, the projection-type display apparatus 4000 includes three liquid crystal devices 1r, 1g and 1b that correspond to display colors of red, green and blue, respectively. An illumination optical system 4001 supplies the liquid crystal device 1r with a red color component r of light emitted from an illumination device 4002 serving as a light source, supplies the liquid crystal device 1g with a green color component g, and supplies the liquid crystal device 1b with a blue color component b. Each of the liquid crystal devices 1r, 1g and 1b functions as a light modulator such as a light valve that modulates individual monochromatic lights supplied from the illumination optical system 4001 according to displayed images. A projection optical system 4003 synthesizes the lights emitted from the liquid crystal devices 1r, 1g and 1b to project the synthesized light to a projection surface 4004. Note that the projection-type display apparatus 4000 may include the liquid crystal device 1A or the liquid crystal device 1B, instead of the liquid crystal device 1.

Each of the above-described personal computer 2000, the smartphone 3000, and the projection-type display device 4000 includes the liquid crystal device 1, the liquid crystal device 1A, or the liquid crystal device 1B described above, and hence, it is possible to improve the image quality of the displayed image.

Note that, in addition to the devices illustrated in FIGS. 10, 11, and 12, the electronic apparatus to which the present disclosure is applied includes personal digital assistances (PDA), digital still cameras, televisions, video cameras, car navigation devices, on-board indicators, electronic organizers, electronic paper, calculators, word processors, workstations, video phones, point of sale (POS) terminals, and the like. Furthermore, other examples of the electronic apparatus to which the present disclosure include an apparatus including a printer, a scanner, a copier, a video player, or a touch panel, and the like.

The liquid crystal device and the electronic apparatus according to the present disclosure are not limited to the exemplary embodiments described above. In addition, the configuration of each component according to the present disclosure may be replaced with any configuration that exerts the equivalent functions of the above-described exemplary embodiments. Furthermore, it may be possible to add any configuration to the configuration of each component according to the present disclosure.

What is claimed is:

1. A liquid crystal device performing, at a predetermined frame rate, image writing of supplying a video signal to a pixel via a signal line, the liquid crystal device comprising:
an inversion period setting unit configured to set an inversion period, in which a polarity of the video signal is inverted, to be a length that includes two or more frames for performing the image writing; and
a pre-charge unit configured to perform, in a predetermined period from inversion of the polarity of the video signal until elapse of the inversion period, pre-charge, in which a pre-charge signal is supplied to the signal line, for a first frame but not to perform the pre-charge for at least one frame among second and subsequent frames.

2. The liquid crystal device according to claim 1, wherein the pre-charge is a negative-polarity pre-charge for supplying to the signal line a voltage, which is less than a center voltage of the video signal and equal to or greater than a minimum voltage of the video signal, as the pre-charge signal.

3. The liquid crystal device according to claim 1, wherein the pre-charge unit performs, when three or more frames are included in the predetermined period, the pre-charge for a first frame and a third frame in the predetermined period but does not perform the pre-charge for a second frame.

4. The liquid crystal device according to claim 2, wherein the pre-charge unit performs, in a positive polarity period being the predetermined period from inversion of a polarity of the video signal from a negative polarity to a positive polarity until elapse of the inversion period, supplementary pre-charge, in which a voltage equal to or greater than a center voltage of the video signal and equal to or less than a maximum voltage of the video signal is supplied to the signal line, after performing the negative-polarity pre-charge for the first frame.

5. The liquid crystal device according to claim 4, wherein the pre-charge unit performs, when three or more frames are included in the predetermined period, the negative-polarity pre-charge for a first frame and a third frame in the predetermined period but does not perform the pre-charge for a second frame, and the pre-charge unit performs, in the positive polarity period, the supplementary pre-charge after performing the negative-polarity pre-charge for the first frame but does not perform the supplementary pre-charge for the third frame.

6. The liquid crystal device according to claim 1, comprising a frame-rate setting unit configured to set, when the video signal is updated in a predetermined update period, the predetermined frame rate to be a frame rate at which two or more frames for performing the image writing are included in the predetermined update period.

7. An electronic apparatus comprising the liquid crystal device according to claim 1.
